(19) United States
(12) Patent Application Publication
(10) Pub. No.: US 2023/0385603 A1
(43) Pub. Date: Nov. 30, 2023

(54) NEURAL ARCHITECTURE SEARCH SYSTEM AND SEARCH METHOD

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Tsutomu Takeya, Tokyo (JP); Takeshi Sakamoto, Tokyo (JP)

(21) Appl. No.: 18/249,723

(22) PCT Filed: Nov. 12, 2020
(86) PCT No.: PCT/JP2020/042265

§ 371 Date: Apr. 19, 2023

(51) Int. Cl. G06N 3/04; G06N 3/08

(52) U.S. Cl. CPC G06N 3/04; G06N 3/08

(57) ABSTRACT

A neural architecture search system includes a deployment constraint management unit that converts a first constraint condition that defines a constraint of a system that implements a neural network into a second constraint condition that defines a constraint of a parameter that prescribes an architecture of the neural network, a learning engine unit that performs learning of the neural network under a search condition and calculates inference accuracy in a case where the learned neural network is used, and a model modification unit that causes the learning engine unit to perform the learning and the calculation of the inference accuracy while changing the architecture of the neural network on the basis of the inference accuracy and the second constraint condition so as to obtain the best inference accuracy.

### CROSS-REFERENCE TO RELATED APPLICATIONS

This patent application is a national phase filing under section 371 of PCI application no. PCI/JP2020/042265, filed on Nov. 12, 2020, which application is hereby incorporated herein by reference in its entirety.

### TECHNICAL FIELD

The present invention relates to a neural architecture search system that searches for an architecture of a neural network.

### BACKGROUND

In recent years, an amount of generated data has explosively increased with an increase in the number of edge devices such as mobile terminals and Internet of Things (IoT) devices. In order to extract meaningful information from the enormous pieces of data, a state-of-the-art machine learning technology called deep neural networks (DNNs) is superior. With the recent progress of studies on the DNNs, accuracy of data analysis has been greatly improved, and further development of technologies using the DNNs is expected.

Processing of the DNNs has two phases, i.e., learning and inference. In general, the learning requires a large amount of data, and therefore the data is processed by cloud computing in some cases. Meanwhile, in the inference, a learned DNN model is used to estimate output for unknown input data.

More specifically, in inference processing in the DNNs, input data such as time-series data or image data is given to a learned neural network model, and a feature of the input data is inferred.

For example, according to a specific example disclosed in Non Patent Literature 1, a sensor terminal equipped with an acceleration sensor and a gyro sensor is used to detect an event such as rotation or stop of a waste collection vehicle, thereby estimating an amount of waste. As described above, in order to estimate an event at each time by using unknown time-series data as input, a neural network model that has performed learning in advance by using time-series data in which an event at each time is known is used.

In the example disclosed in Non Patent Literature 1, time-series data acquired from the sensor terminal is used as the input data, and an event needs to be extracted in real time. Therefore, it is necessary to further increase speed of the inference processing. In a conventional technology, a field programmable gate array (FPGA) that implements the processing is mounted on a sensor terminal, and such an FPGA performs an inference operation to increase processing speed (see Non Patent Literature 2).

Meanwhile, neural network processing is required in processing devices such as IoT devices whose computing performance and power consumption are greatly constrained. For such a demand, a system that searches for an optimal neural network architecture is disclosed (see Non Patent Literature 3).

In the conventional technology, a neural network architecture is searched for according to a search condition specified by a user. However, a constraint condition assuming deployment of processing of a neural network is not added to the search condition in a system that implements the neural network, and thus there is a problem that it is difficult to satisfy performance of actual processing devices and a requirement of a communication network.

### CITATION LIST

### Non Patent Literature

Non Patent Literature 1: Yasue Kishino, et. al, “Detecting garbage collection duration using motion sensors mounted on a garbage truck toward smart waste management”, SPWID2017: The Third International Conference on Smart Portable, Wearable, Implantable and Disability-oriented Devices and Systems.
Non Patent Literature 2: Yasue Kishino, et. al, “Datafying city: detecting and accumulating spatio-temporal events by vehicle-mounted sensors”, 2017 IEEE International Conference on Big Data (BIGDATA).
Non Patent Literature 3: Shizuma Namekawa and Taro Tezuka, “Proposed Automatic Optimization Technique of Network Structure in Deep Learning Using Information Theory”, DEIM 2019.

### SUMMARY

### Technical Problem

Embodiments of the present invention can solve the above-described problem, and an embodiment thereof is to provide a neural architecture search system and search method capable of searching for an architecture of a neural network that can satisfy constraints of a processing device and a communication network.

### Solution to Problem

A neural architecture search system according to embodiments of the present invention includes: a search parameter setting unit configured to set a search condition of an architecture of a neural network; a deployment constraint management unit configured to convert a first constraint condition that defines a constraint of a system that implements the neural network into a second constraint condition that defines a constraint of a parameter that prescribes the architecture of the neural network; a learning engine unit configured to input training data to the neural network, perform learning of the neural network under the search condition, and calculate inference accuracy in a case where inference is performed by using the learned neural network; and a model modification unit configured to cause the learning engine unit to repeatedly perform the learning and the calculation of the inference accuracy while changing the architecture of the neural network on the basis of the inference accuracy and the second constraint condition so as to obtain the best inference accuracy.

In a configuration example of the neural architecture search system according to embodiments of the present invention, the model modification unit causes the learning engine unit to perform the learning and the calculation of the inference accuracy while changing the architecture of the neural network a plurality of times so as to satisfy the second constraint condition and obtains, as a final search result, an architecture having the best inference accuracy among a plurality of architectures of the neural network obtained by the plurality of times of learning.

In the configuration example of the neural architecture search system according to embodiments of the present invention, the learning engine unit repeatedly changes the architecture of the neural network and performs the learning under the search condition and obtains an architecture having the best inference accuracy as a learning result.

In the configuration example of the neural architecture search system according to embodiments of the present invention, the deployment constraint management unit converts an external setting parameter input by a user as the first constraint condition into the second constraint condition.

In a configuration example of the neural architecture search system according to embodiments of the present invention, the deployment constraint management unit converts communication network information as the first constraint condition into the second constraint condition, the communication network information defining a constraint of a communication network that connects processing devices of the system that implements the neural network.

In a configuration example of the neural architecture search system according to embodiments of the present invention, the deployment constraint management unit converts device information as the first constraint condition into the second constraint condition, the device information defining a constraint of processing devices of the system that implements the neural network.

In a configuration example of the neural architecture search system according to embodiments of the present invention, the deployment constraint management unit converts at least one of an external setting parameter input by a user, communication network information that defines a constraint of a communication network that connects processing devices of the system that implements the neural network, and device information that defines a constraint of the processing devices of the system that implements the neural network as the first constraint condition into the second constraint condition.

A neural architecture search method according to embodiments of the present invention includes: a first step of setting a search condition of an architecture of a neural network; a second step of converting a first constraint condition that defines a constraint of a system that implements the neural network into a second constraint condition that defines a constraint of a parameter that prescribes the architecture of the neural network; a third step of inputting training data to the neural network, performing learning of the neural network under the search condition, and calculating inference accuracy in a case where inference is performed by using the learned neural network; and a fourth step of repeatedly executing the third step while changing the architecture of the neural network on the basis of the inference accuracy and the second constraint condition so as to obtain the best inference accuracy.

### Advantageous Effects of Embodiments of the Invention

According to embodiments of the present invention, a deployment constraint management unit is provided, and thus it is possible to set not only a conventional search condition but also a deployment constraint condition in a neural architecture search system. Thus, embodiments of the present invention can satisfy constraints of processing devices and a communication network of a system that implements a neural network and can therefore obtain an architecture of the neural network having an executable scale. In embodiments of the present invention, a constraint condition is added when the architecture of the neural network is searched for, and thus it is possible to limit a search range and thus obtain, in a shorter time, the architecture of the neural network that can achieve desired inference accuracy. In embodiments of the present invention, when the architecture of the neural network is searched for, an optimal architecture of the neural network can be obtained according to operational precision of the processing device. This makes it possible to restrain a decrease in inference accuracy caused by adaptation to the operational precision of the processing devices. Embodiments of the present invention eliminate the need for processing of adapting the searched-for architecture to the operational precision of the processing devices.

### BRIEF DESCRIPTION OF THE DRAWINGS

FIG. 1 is a block diagram illustrating a configuration of a neural architecture search system according to a first embodiment of the present invention.

FIG. 2 is a block diagram illustrating a configuration example of a neural network system according to the first embodiment of the present invention.

FIG. 3 illustrates an example of a neural network according to the first embodiment of the present invention.

FIG. 4 is a block diagram illustrating a configuration of a deployment constraint management unit of the neural architecture search system according to the first embodiment of the present invention.

FIG. 5 is a block diagram illustrating a configuration of a conventional neural architecture search system.

FIG. 6 is a flowchart showing an operation of the neural architecture search system according to the first embodiment of the present invention.

FIG. 7 is a block diagram illustrating a configuration of a deployment constraint management unit of a neural architecture search system according to a second embodiment of the present invention.

FIG. 8 is a block diagram illustrating a configuration of a deployment constraint management unit of a neural architecture search system according to a third embodiment of the present invention.

FIG. 9 is a block diagram illustrating a configuration of a deployment constraint management unit of a neural architecture search system according to a fourth embodiment of the present invention.

FIG. 10 is a block diagram illustrating a configuration example of a computer that implements the neural architecture search systems according to the first to fourth embodiments of the present invention.

### DETAILED DESCRIPTION OF ILLUSTRATIVE EMBODIMENTS

Next, embodiments of the present invention will be described with reference to the drawings.

### Configuration of the First Embodiment

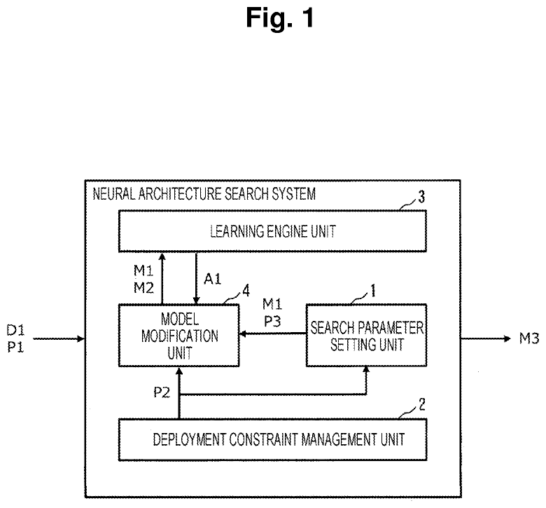

First, a neural architecture search system according to a first embodiment of the present invention will be described with reference to FIGS. 1 to 6. FIG. 1 is a block diagram illustrating a configuration of the neural architecture search system according to this embodiment.

The neural architecture search system according to this embodiment performs learning of a neural network by using training data as input, calculates inference accuracy in a case where inference is performed by using the learned neural network, and repeatedly performs the learning and the calculation of the inference accuracy while changing an architecture of the neural network so as to improve the inference accuracy, thereby searching for the architecture of the neural network having satisfactory inference accuracy.

The neural architecture search system includes: a search parameter setting unit 1 that sets a search condition of an architecture of a neural network; a deployment constraint management unit 2 that converts a first constraint condition that defines a constraint of a system that implements the neural network into a second constraint condition that defines a constraint of a parameter that prescribes the architecture of the neural network; a learning engine unit 3 that inputs training data D1 to the neural network, performs learning of the neural network under the search condition, and calculates inference accuracy in a case where inference is performed by using the learned neural network; a model modification unit 4 that causes the learning engine unit 3 to repeatedly perform the learning and the calculation of the inference accuracy while changing the architecture of the neural network on the basis of the inference accuracy and the second constraint condition so as to obtain the best inference accuracy.

Examples of the search condition used to search for the architecture of the neural network include the number of times of repeating improvement (generally referred to as the number of generations), the number of child models prepared in each generation, and the number of epochs.

More specifically, in the neural architecture search system, a child model is prepared by changing part of an architecture (parent model) of a base neural network. A predetermined number of epochs of learning is performed on the child model, and inference accuracy of the learned child model is calculated.

In a case where the inference accuracy is high, a grandchild model is prepared by changing part of the architecture of the neural network of the child model. A predetermined number of epochs of learning is performed on the grandchild model, and inference accuracy of the learned grandchild model is calculated. By gradually improving the architecture of the neural network by using the training data as described above, the architecture of the neural network having high inference accuracy is searched for.

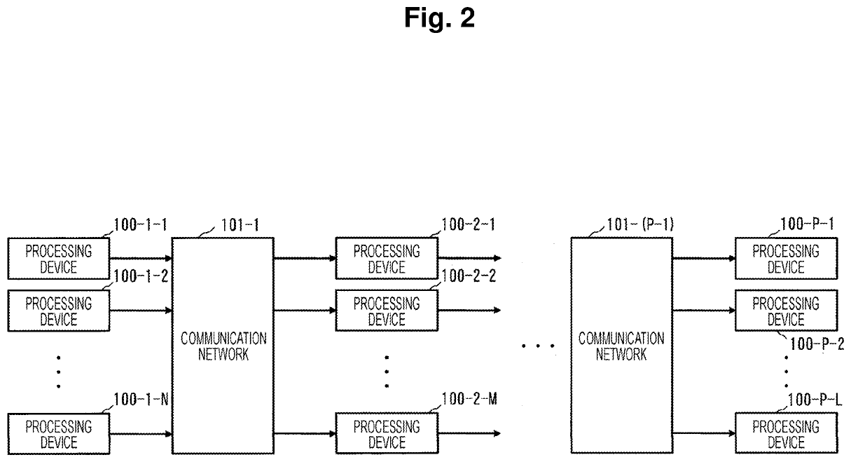

As illustrated in FIG. 2, a neural network is built on a system including N (N is an integer of 1 or more) processing devices 100-1-1 to 100-1-N, M (M is an integer of 1 or more) processing devices 100-2-1 to 100-2-M, L (L is an integer of 1 or more) processing devices 100-P-1 to 100-P-L (P is an integer of 2 or more), and communication networks 101-1 to 101-(P-1) that connect the processing devices.

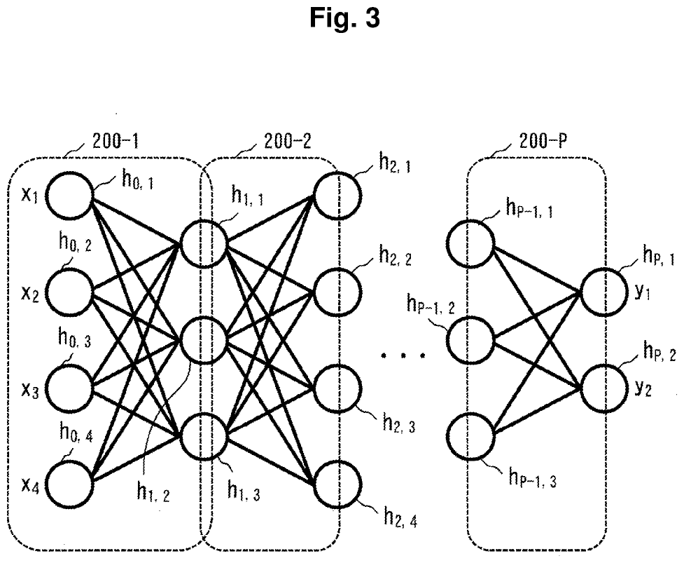

An example of the neural network is illustrated in FIG. 3. The neural network includes P layers of 200-1 to 200-P. Units h_{0.1} to h_{0.4}, h_{1.1} to h_{1.3}, h_{2.1} to h_{2.4} and h_{P-1.1} to h_{P-1.3} are included in the layers. For example, in the example of FIG. 3, the neural network estimates two pieces of output data y₁ and y₂ from four pieces of input data x₁, x₂, x₃, and x₄.

The processing devices 100-1-1 to 100-1-N in FIG. 2 perform processing of the layer 200-1, the processing devices 100-2-1 to 100-2-M perform processing of the layer 200-2, and the processing devices 100-P-1 to 100-P-L perform processing of the layer 200-P.

In a case where data requiring privacy protection or data requiring security protection is treated as input data of the neural network, it is necessary to perform encryption or the like in order to transmit the input data to a general cloud server shared by a plurality of users or services.

Meanwhile, in this embodiment, the neural network is divided into a plurality of processing devices to perform inference processing. The processing devices 100-1-1 to 100-1-N that receive input data transmit intermediate data of neural network processing to the communication network 101-1.

The intermediate data is obtained by performing some arithmetic processing on the input data and thus is numerical data different from the input data. Therefore, dividing a neural network into a plurality of processing devices is suitable for a case where data requiring privacy protection or data requiring security protection is treated as input data.

The first processing devices 100-1-1 to 100-1-N are IoT devices such as security cameras or sensor terminals in some cases, and thus sufficient computing performance may not be obtained. By dividing the neural network into the plurality of processing devices, the processing devices 100-2-1 to 100-2-M, . . . , and 100-P-1 to 100-P-L having relatively high computing performance can be used via the communication networks. Examples of the processing devices 100-2-1 to 100-2-M, . . . , and 100-P-1 to 100-P-L include an edge server.

The processing devices 100-2-1 to 100-2-M, . . . , and 100-P-1 to 100-P-L can also obtain an inference result by aggregating a plurality of pieces of output data of the processing devices 100-1-1 to 100-1-N.

By aggregating a plurality of pieces of data, inference accuracy may be improved. For example, in a case where an object is detected by using videos of security cameras captured from various directions, a blind spot occurs in inference processing based only on video data from one direction. By aggregating video data from the various directions, it is possible to prevent occurrence of a blind spot and improve detection accuracy.

One feature of the neural architecture search system of this embodiment is that the architecture of the neural network is searched for so as to satisfy a constraint condition specified by a user as an external setting parameter P1.

For example, in a case where a processing time from when data is input to the neural network until when an inference result of the neural network is transmitted to a predetermined device, that is, end-to-end latency, is defined as a constraint condition, it is necessary to search for the architecture of the neural network not only having high inference accuracy but also satisfying the constraint condition.

Even in a case where the neural network has high inference accuracy, the neural network cannot be adopted if the neural network cannot complete processing within a prescribed processing time defined by the system. In view of this, the architecture of the neural network suitable for an operation environment such as performance of the processing devices and a system configuration is searched for.

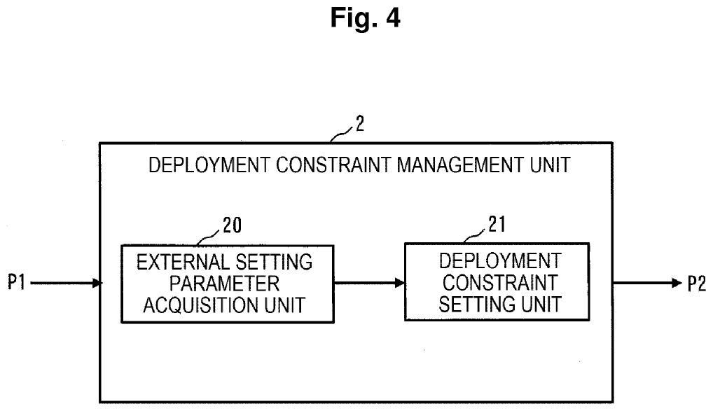

FIG. 4 is a block diagram illustrating a configuration of the deployment constraint management unit 2. The deployment constraint management unit 2 includes: an external setting parameter acquisition unit 20 that acquires an external setting parameter P1 (first constraint condition) that defines a constraint of the system that implements the neural network; and a deployment constraint setting unit 21 that converts the external setting parameter P1 into a deployment constraint parameter P2 (second constraint condition) that defines a constraint of a parameter that prescribes the architecture of the neural network.

The user specifies, as the external setting parameter P1, constraint conditions such as information regarding the computing performance of the processing devices 100-1-1 to 100-1-N, 100-2-1 to 100-2-M, . . . , and 100-P-1 to 100-P-L and information regarding a constraint on power consumption thereof.

For example, in a case where a neural network searched for by a conventional technology has high inference accuracy but has a complicated configuration and a large amount of computation, the neural network may not satisfy an end-to-end latency requirement defined by a system requirement. Even though a search cost is spent to search for the architecture of the neural network, the architecture cannot be adopted because the architecture does not satisfy the system requirement.

In order to avoid such a situation, in this embodiment, the architecture of the neural network suitable for an available calculation resource is searched for.

Specifically, the available calculation resource is limited, and the computing performance of the processing devices 100-1-1 to 100-1-N, 100-2-1 to 100-2-M, . . . , and 100-P-1 to 100-P-L is known.

Further, computing performance required for processing of the neural network can be specified or analogized on the basis of, for example, the number of parameters of the neural network. The computing performance required for the processing of the neural network needs to be lower than available computing performance of the processing devices 100-1-1 to 100-1-N, 100-2-1 to 100-2-M, . . . , and 100-P-1 to 100-P-L.

Capacities of memories included in the processing devices 100-1-1 to 100-1-N, 100-2-1 to 100-2-M, . . . , and 100-P-1 to 100-P-L are also limited. In order to build the neural network on the system in FIG. 2 including the processing devices 100-1-1 to 100-1-N, 100-2-1 to 100-2-M, . . . , and 100-P-1 to 100-P-L, it is necessary to store parameters of the neural network in the memories.

Therefore, in this embodiment, the architecture of the neural network suitable for available memory capacities is searched for. Specifically, the available memory capacities are limited, and the memory capacities of the processing devices 100-1-1 to 100-1-N, 100-2-1 to 100-2-M, . . . , and 100-P-1 to 100-P-L are known.

A memory capacity required for the processing of the neural network can be obtained on the basis of, for example, the number of parameters of the neural network.

The memory capacity required for the processing of the neural network needs to be lower than available memory capacities of the processing devices 100-1-1 to 100-1-N, 100-2-1 to 100-2-M, . . . , and 100-P-1 to 100-P-L.

In a case where a neural network searched for by a conventional technology has high inference accuracy but has a complicated configuration and a large amount of computation, the neural network may not satisfy an upper limit value of power consumption defined by a system requirement. In order to avoid a situation in which, although a search cost is spent to search for the architecture of the neural network, the architecture cannot be adopted because the architecture does not satisfy the system requirement, in this embodiment, the architecture of the neural network suitable for power consumption allowed by each processing device is searched for.

Specifically, for example, a time during which an IoT device or the like can continuously operate on a single charge is defined, allowable power consumption is limited, and power consumption of the processing devices 100-1-1 to 100-1-N, 100-2-1 to 100-2-M, . . . , and 100-P-1 to 100-P-L is known.

Power consumption required for the processing of the neural network can be calculated on the basis of, for example, the number of parameters of the neural network.

The power consumption required for the processing of the neural network needs to be lower than the power consumption allowed by the processing devices 100-1-1 to 100-1-N, 100-2-1 to 100-2-M, . . . , and 100-P-1 to 100-P-L.

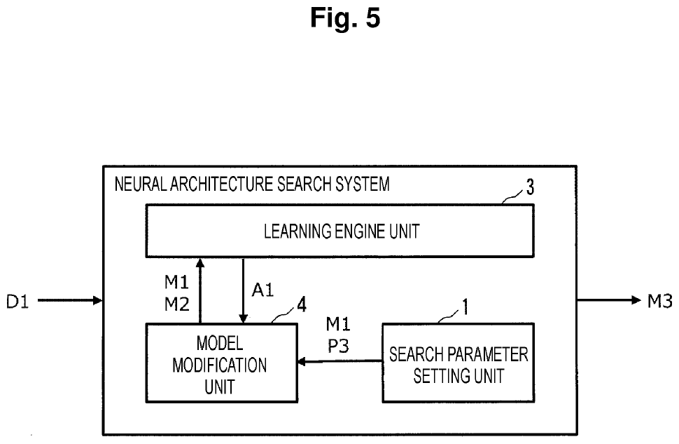

FIG. 5 is a block diagram illustrating a configuration of a conventional neural architecture search system. The neural architecture search system of this embodiment is different from the conventional system in that the deployment constraint management unit 2 is provided. The conventional neural architecture search system searches for an architecture of a neural network by using only search conditions such as the number of generations, the number of child models prepared in each generation, and the number of epochs, without considering constraint conditions such as a processing time and power consumption required for inference processing of input data using the neural network.

Meanwhile, the neural architecture search system of this embodiment searches for an architecture of a neural network under a condition in which constraints imposed when the neural network is deployed in the system, specifically, constraints such as the computing performance of the processing devices, the power consumption, a battery life, and a processing time required to complete processing are added to the conventional search conditions. Therefore, in this embodiment, an architecture of a neural network having a scale processable in the system of FIG. 2 can be obtained when the search is completed.

Further, in this embodiment, a constraint condition is added when the architecture of the neural network is searched for, and thus it is possible to limit a search range and thus obtain, in a shorter time, the architecture of the neural network that can achieve desired inference accuracy.

Furthermore, the conventional neural architecture search system searches for an architecture of a neural network and then performs processing of adapting the architecture to operational precision of processing devices (quantization processing such as binarization). Thus, inference accuracy may decrease. Meanwhile, in this embodiment, when an architecture of a neural network is searched for, an optimal architecture of the neural network can be obtained according to the operational precision of the processing devices. Thus, it is possible to restrain a decrease in inference accuracy caused by a decrease in the operational precision.

### Operation of the First Embodiment

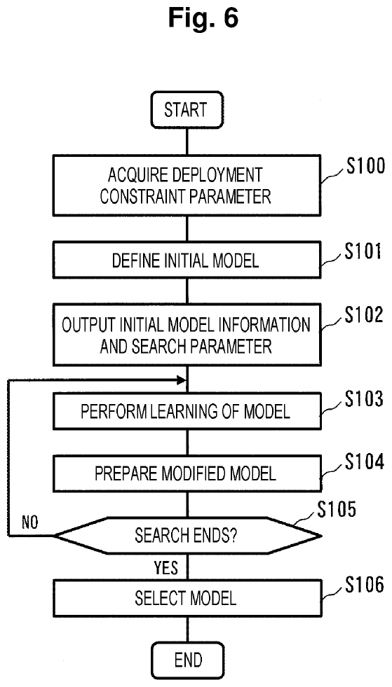

Next, an operation of the neural architecture search system of this embodiment will be described with reference to FIG. 6. FIG. 6 is a flowchart showing the operation of the neural architecture search system.

As described above, the user inputs, to the neural network architecture search system, the external setting parameter P1 indicating a constraint condition such as the computing performance or power consumption of the processing devices or a processing time required to complete processing.

The external setting parameter acquisition unit 20 of the deployment constraint management unit 2 acquires the input external setting parameter P1.

The deployment constraint setting unit 21 of the deployment constraint management unit 2 converts the constraint condition specified by the external setting parameter P1 into the deployment constraint parameter P2 that defines a constraint of a parameter that prescribes an architecture of a neural network and outputs the constraint parameter P2 (step S100 in FIG. 6).

Examples of the deployment constraint parameter P2 include the number of parameters of the neural network, the number of layers, the number of neurons, and information regarding operational precision used in a neural network learning process.

A table storing a correspondence between the external setting parameter P1 and the deployment constraint parameter P2 is set in the deployment constraint setting unit 21. The deployment constraint setting unit 21 acquires the deployment constraint parameter P2 corresponding to the external setting parameter P1 from the table.

Next, the search parameter setting unit 1 defines an initial model of the neural network on the basis of the deployment constraint parameter P2 (step S101 in FIG. 6).

Then, the search parameter setting unit 1 outputs initial model information M1 indicating an architecture of the initial model and a search parameter P3 indicating a preset search condition (step S102 in FIG. 6). As described above, examples of the search parameter P3 include the number of generations, the number of child models prepared in each generation, and the number of epochs.

Next, the learning engine unit 3 inputs the training data D1 to the initial model of the neural network prescribed by the initial model information M1 and performs learning of the initial model under the search condition specified by the search parameter P3 (step S103 in FIG. 6). The training data D1 includes a label indicating a correct answer. A procedure of the learning here is as follows: steps (I) to (V). This learning method is disclosed in Non Patent Literature 3.
(I)—The initial model is used as a base model.
(II)—The initial model is used as the base model, and child models are prepared by the number specified by the search condition by changing the architecture of the base model.
(III)—The number of epochs of learning is performed on the base model and the newly prepared child models.
(IV)—A model having the best performance among the initial model and the child models is selected as a base of the next generation. The performance is inference accuracy obtained in a case where the neural network is used for inference.
(V)—(II) to (IV) are repeated by the number of generations specified by the search condition.

As described above, the learning engine unit 3 gradually improves the model of the neural network. Then, the learning engine unit 3 sets a model having the best inference accuracy in the last generation as a model of a final learning result, calculates inference accuracy information A1 in a case where inference is performed by inputting the training data D1 to the model, and outputs the inference accuracy information (step S103).

Next, the model modification unit 4 changes part of an architecture of the model searched for by the learning engine unit 3 on the basis of the inference accuracy information A1 acquired from the learning engine unit 3 and the deployment constraint parameter P2 acquired from the deployment constraint management unit 2 (step S104 in FIG. 6).

Specifically, the model modification unit 4 increases or decreases the number of layers of the neural network, increases or decreases the number of neurons, or increases or decreases the operational precision so as to satisfy the constraint condition specified by the deployment constraint parameter P2. Then, the model modification unit 4 outputs model information M2 indicating an architecture of the modified model.

Next, the learning engine unit 3 inputs the training data D1 to the model of the neural network prescribed by the model information M2 and performs learning of the model under the search condition specified by the search parameter P3 (step S103).

The procedure of the learning here is the same as (I) to (V), except that the model prescribed by the model information M2 is used as the base model instead of the initial model in (I) described above. Similarly to the above, the learning engine unit 3 sets a model having the best inference accuracy in the last generation as a model of a search result and outputs the inference accuracy information A1 in a case where inference is performed by inputting the training data D1 to the model.

The architecture of the neural network is repeatedly modified and learned as described above so as to satisfy a deployment constraint, and the architecture of the neural network is searched for so as to improve performance.

The model modification unit 4 determines that the search ends when a predetermined number of modifications is performed or a predetermined time elapses (YES in step S105 in FIG. 6).

After the search ends, the model modification unit 4 selects a model having the best inference accuracy from among the plurality of models searched for by the learning engine unit 3 in the processing in step S104 and outputs model information M3 indicating an architecture of the selected model as a final search result (step S106 in FIG. 6).

### Effects of the First Embodiment

As described above, in this embodiment, the user sets a constraint condition in a case where the user gives not only a conventional search condition but also a deployment constraint condition to the neural architecture search system. Therefore, it is possible to obtain an architecture of a neural network having a scale executable in the system of FIG. 2.

In this embodiment, the constraint condition is added when the architecture of the neural network is searched for, and thus it is possible to limit a search range and thus obtain, in a shorter time, the architecture of the neural network that can achieve desired inference accuracy.

In this embodiment, when the architecture of the neural network is searched for, an optimal architecture of the neural network can be obtained according to the operational precision of the processing devices. This makes it possible to restrain a decrease in the inference accuracy caused by adaptation to the operational precision of the processing devices. This embodiment eliminates the need for processing of adapting the searched-for architecture to the operational precision of the processing devices.

### Configuration of the Second Embodiment

Next, a second embodiment of the present invention will be described. A configuration of an entire neural architecture search system in this embodiment is also similar to that in the first embodiment, and thus description will be made by using reference signs in FIG. 1.

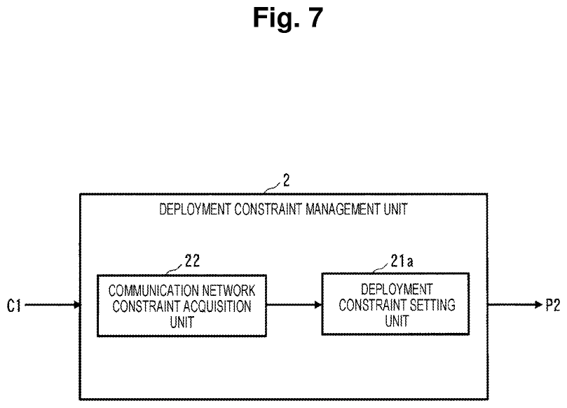

FIG. 7 is a block diagram illustrating a configuration of the deployment constraint management unit 2 of the neural architecture search system according to this embodiment. The deployment constraint management unit 2 of this embodiment includes: a communication network constraint acquisition unit 22 that acquires communication network information C1 (first constraint condition) that defines a constraint of a communication network connecting processing devices of a system that implements a neural network; and a deployment constraint setting unit 21a that converts the communication network information C1 into the deployment constraint parameter P2 (second constraint condition).

A flow of processing of the neural architecture search system is similar to that in the first embodiment. The communication network constraint acquisition unit 22 of the deployment constraint management unit 2 acquires the communication network information C1 indicating a constraint condition of the communication network connecting the processing devices of the neural network system. For example, in the example of the neural network system in FIG. 2, the communication networks 101-1 to 101-(P-1) that connect the processing devices are provided.

Examples of the communication network information C1 include a communication bandwidth (e.g., 10 Gbpps or 100 Gbps), a transmission distance between the processing devices, a communication time between the processing devices, radio wave sensitivity of the processing devices obtained in a case where the processing devices are wireless terminals, the number of users or the number of terminals included in the communication networks, and information regarding a congestion status of the communication networks.

In general, the communication network includes a network management unit (not illustrated) that provides a management function. The network management unit performs processing such as holding various kinds of information regarding the network, monitoring the network, and handling a failure. The communication network constraint acquisition unit 22 acquires the communication network information C1 from an external device such as the network management unit.

The deployment constraint setting unit 21a of the deployment constraint management unit 2 sets the communication network information C1 as a constraint condition, converts the constraint condition into the deployment constraint parameter P2 that prescribes an architecture of the neural network, and outputs the constraint parameter P2 (step S100 in FIG. 6).

In a case where the neural network is divided into a plurality of processing devices and the communication bandwidth of the communication networks between the processing devices has a large capacity, processing performance of the neural network such as a processing time and latency is less affected even when an amount of data to be exchanged increases.

Meanwhile, in a case where the communication bandwidth of the communication networks between the processing devices has a small capacity and the amount of data to be exchanged is large, a communication time caused by the exchange of data non-negligibly increases. Thus, the processing performance such as a processing time and latency is affected.

In a case where the communication bandwidth of the communication networks between the processing devices has a large capacity, the amount of data to be exchanged between the processing devices may not be constrained, or the constraint may be eased. In a case where the communication bandwidth of the communication networks between the processing devices has a small capacity, it is necessary to search for the architecture of the neural network by imposing a constraint such as reducing the number of parameters of the neural network corresponding to a portion between the processing devices, reducing the number of neurons, or applying a generally known method of reducing the number of parameters of the neural network.

A table storing a correspondence between the constraint condition specified by the communication network information C1 and the deployment constraint parameter P2 is set in the deployment constraint setting unit 21a in a similar manner to the deployment constraint setting unit 21. The deployment constraint setting unit 21a acquires the deployment constraint parameter P2 corresponding to the communication network information C1 from the table. Searching for the architecture according to the communication bandwidth as described above can be implemented by a setting of the table of the deployment constraint setting unit 21a.

Operations of the search parameter setting unit 1, the learning engine unit 3, and the model modification unit 4 (steps S101 to S106 in FIG. 6) are as described in the first embodiment.

### Effects of the Second Embodiment

As described above, in this embodiment, in a case where not only a conventional search condition but also a deployment constraint condition is given to the neural architecture search system, the communication network information is collected, and a constraint condition is set. Therefore, it is possible to obtain an architecture of a neural network that can satisfy a constraint of the communication networks and has a scale executable in the system of FIG. 2.

In this embodiment, the constraint condition is added when the architecture of the neural network is searched for, and thus it is possible to limit a search range and thus obtain, in a shorter time, the architecture of the neural network that can achieve desired inference accuracy. Further, unlike the first embodiment, the user does not need to specify the constraint condition in this embodiment.

In this embodiment, when the architecture of the neural network is searched for, an optimal architecture of the neural network can be obtained according to the operational precision of the processing devices. This makes it possible to restrain a decrease in the inference accuracy caused by adaptation to the operational precision of the processing devices. This embodiment eliminates the need for processing of adapting the searched-for architecture to the operational precision of the processing devices after the architecture of the neural network is searched for.

In this embodiment, in a case where the collected communication network information includes information regarding power consumption caused by the processing of the communication networks, it is possible to search for the architecture of the neural network so as to reduce total power consumption of all the communication networks. This makes it possible to reduce the power consumption of the system in FIG. 2.

In this embodiment, in a case where the communication network information includes information regarding a processing time of the communication networks, it is possible to search for the architecture of the neural network so as to reduce an end-to-end processing time. This makes it possible to reduce the end-to-end processing time.

In this embodiment, in a case where the communication network information includes information regarding an amount of communication load, it is possible to search for the architecture of the neural network so as to reduce the amount of communication load.

Specifically, it is possible to search for the architecture of the neural network so as to avoid a congested path having a high communication load, such as a path having a large number of connected processing devices or a path used for a service in which large capacity data is exchanged. Therefore, it is possible not only to reduce the processing time of each communication network and reduce the end-to-end processing time, but also to reduce the communication load of the entire system or distribute the communication load.

In this embodiment, in a case where the communication network information includes information regarding a communication bandwidth and the communication bandwidth has a small capacity, it is possible to search for the architecture of the neural network so as to avoid a communication network having a small capacity. Meanwhile, in a case where the communication bandwidth has a large capacity, it is possible to search for the architecture of the neural network so as to improve the inference accuracy by using a large-capacity communication network. Therefore, it is possible to search for the architecture of the neural network not only to reduce the processing time of each communication network and reduce the end-to-end processing time, but also to improve the inference accuracy.

### Configuration of the Third Embodiment

Next, a third embodiment of the present invention will be described. A configuration of an entire neural architecture search system in this embodiment is also similar to that in the first embodiment, and thus description will be made by using reference signs in FIG. 1.

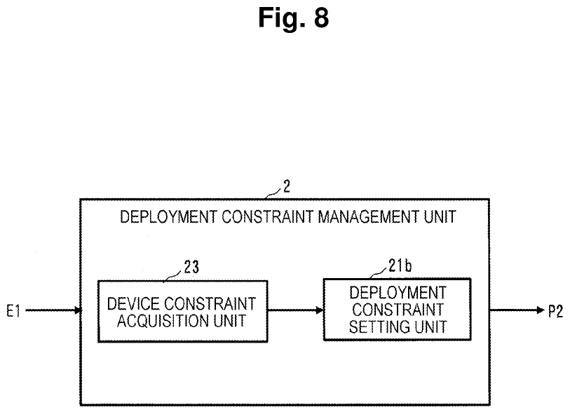

FIG. 8 is a block diagram illustrating a configuration of the deployment constraint management unit 2 of the neural architecture search system according to this embodiment. The deployment constraint management unit 2 of this embodiment includes: a device constraint acquisition unit 23 that acquires device information E1 (first constraint condition) that defines a constraint of processing devices of a system that implements a neural network; and a deployment constraint setting unit 21b that converts the device information E1 into the deployment constraint parameter P2 (second constraint condition).

A flow of processing of the neural architecture search system is similar to that in the first embodiment. The device constraint acquisition unit 23 of the deployment constraint management unit 2 acquires the device information E1 indicating a constraint condition of the processing devices of the neural network system. Examples of the device information E1 include information regarding computing performance of the processing devices, information regarding a constraint on power consumption (e.g., battery capacity), and information regarding a memory capacity.

In general, the neural network system in FIG. 2 includes a system management unit (not illustrated) that provides a management function. The system management unit performs processing such as holding various kinds of information regarding the system, monitoring the system, and handling a failure. The device constraint acquisition unit 23 acquires the device information E1 from an external device such as the system management unit.

The deployment constraint setting unit 21b of the deployment constraint management unit 2 sets the device information E1 as a constraint condition, converts the constraint condition into the deployment constraint parameter P2 that prescribes an architecture of the neural network, and outputs the constraint parameter P2 (step S100 in FIG. 6).

A table storing a correspondence between the constraint condition specified by the device information E1 and the deployment constraint parameter P2 is set in the deployment constraint setting unit 21b in a similar manner to the deployment constraint setting unit 21. The deployment constraint setting unit 21b acquires the deployment constraint parameter P2 corresponding to the device information E1 from the table.

Operations of the search parameter setting unit 1, the learning engine unit 3, and the model modification unit 4 (steps S101 to S106 in FIG. 6) are as described in the first embodiment.

In a case where the neural network is divided into a plurality of processing devices and, for example, computing performance of a second processing device is higher than computing performance of a first processing device, a processing time and latency can be reduced more by performing a large amount of computation in the second processing device than by performing a large amount of computation in the first processing device. In view of this, the architecture of the neural network is searched for such that the first processing device performs a smaller amount of computation.

In a case where the neural network is divided into a plurality of processing devices and, for example, a battery capacity of the first processing device is smaller than a battery capacity of the second processing device, inference processing can be performed for a longer time by performing a large amount of computation in the second processing device than by performing a large amount of computation in the first processing device. In view of this, the architecture of the neural network is searched for such that the first processing device performs a smaller amount of computation.

In a case where the neural network is divided into a plurality of processing devices and, for example, a memory capacity of the first processing device is smaller than a memory capacity of the second processing device, the first processing device cannot hold a large amount of data. In view of this, the architecture of the neural network is searched for such that the amount of computation and the number of parameters are reduced.

Searching for the architecture according to the constraints such as the computing performance, the battery capacity, and the memory capacity as described above can be implemented by a setting of the table of the deployment constraint setting unit 21b.

### Effects of the Third Embodiment

As described above, in this embodiment, in a case where not only a conventional search condition but also a deployment constraint condition is given to the neural architecture search system, the device information is collected, and a constraint condition is set. Therefore, it is possible to obtain an architecture of a neural network that can satisfy a constraint of the processing devices and has a scale executable in the system of FIG. 2.

Further, in this embodiment, a constraint condition is added when the architecture of the neural network is searched for, and thus it is possible to limit a search range and thus obtain, in a shorter time, the architecture of the neural network that can achieve desired inference accuracy. Further, unlike the first embodiment, the user does not need to specify the constraint condition in this embodiment.

In this embodiment, when the architecture of the neural network is searched for, an optimal architecture of the neural network can be obtained according to the operational precision of the processing devices. This makes it possible to restrain a decrease in the inference accuracy caused by adaptation to the operational precision of the processing devices. This embodiment eliminates the need for processing of adapting the searched-for architecture to the operational precision of the processing devices after the architecture of the neural network is searched for.

In this embodiment, in a case where the collected device information includes information regarding the computing performance of the processing devices, it is possible to search for the architecture of the neural network so as to complete the inference processing in a short time. This makes it possible to reduce a processing time of inference using the neural network.

In this embodiment, in a case where the device information includes information regarding a constraint on power consumption of the processing devices, it is possible to search for the architecture of the neural network so as to reduce an amount of computation of a processing device having a limited battery capacity or power supply. This makes it possible to operate the processing device having the limited battery capacity or power supply for a longer time.

In this embodiment, in a case where the device information includes information regarding the memory capacities of the processing devices, it is possible to search for the architecture of the neural network so as to reduce the number of parameters for a processing device having a small memory capacity. It is also possible to search for the architecture so as to reduce memory usage caused by holding of intermediate data and also reduce the amount of computation. Further, it is also possible to search for the architecture so as to reduce the operational precision by a quantization method and also reduce an amount of intermediate data and an amount of parameter data to be held. As a result, it is possible to implement the inference processing with a smaller memory capacity and efficiently use the memories in the entire neural network system.

### Configuration of the Fourth Embodiment

Next, a fourth embodiment of the present invention will be described. A configuration of an entire neural architecture search system in this embodiment is also similar to that in the first embodiment, and thus description will be made by using reference signs in FIG. 1.

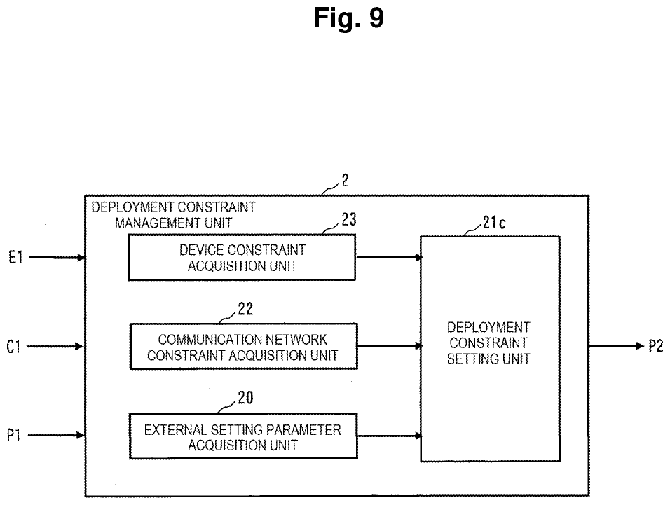

FIG. 9 is a block diagram illustrating a configuration of the deployment constraint management unit 2 of the neural architecture search system according to this embodiment. The deployment constraint management unit 2 of this embodiment includes: the external setting parameter acquisition unit 20; the communication network constraint acquisition unit 22; the device constraint acquisition unit 23; and a deployment constraint setting unit 21c that converts at least one of the external setting parameter P1, the communication network information C1, and the device information E1 into the deployment constraint parameter P2.

A flow of processing of the neural architecture search system is similar to that in the first embodiment. As in the first embodiment, the external setting parameter acquisition unit 20 acquires the external setting parameter P1 input by the user.

The communication network constraint acquisition unit 22 acquires the communication network information C1 indicating a constraint condition of the communication network connecting processing devices of the neural network system. Examples of the communication network information C1 include a communication bandwidth (e.g., 10 Gbpps or 100 Gbps), a transmission distance between the processing devices, a communication time between the processing devices, radio wave sensitivity of the processing devices obtained in a case where the processing devices are wireless terminals, the number of users or the number of terminals included in the communication networks, and information regarding a congestion status of the communication networks.

The device constraint acquisition unit 23 acquires the device information E1 indicating a constraint condition of the processing devices of the neural network system.

Examples of the device information E1 include information regarding computing performance of the processing devices, information regarding a constraint on power consumption (e.g., battery capacity), and information regarding a memory capacity.

The deployment constraint setting unit 21c sets the external setting parameter P1, the communication network information C1, and the device information E1 as constraint conditions, converts the constraint conditions into the deployment constraint parameters P2 that prescribe an architecture of the neural network, and outputs the constraint parameters P2 (step S100 in FIG. 6).

A table storing correspondences between the external setting parameter P1, the communication network information C1, and the device information E1 and the deployment constraint parameters P2 is set in the deployment constraint setting unit 21c. The deployment constraint setting unit 21c acquires the deployment constraint parameters P2 corresponding to the external setting parameter P1, the communication network information C1, and the device information E1 from the table.

It is unnecessary to acquire all of the external setting parameter P1, the communication network information C1, and the device information E1. In a case where at least one of the external setting parameter P1, the communication network information C1, and the device information E1 can be acquired, the corresponding deployment constraint parameter P2 can be acquired from the table.

Operations of the search parameter setting unit 1, the learning engine unit 3, and the model modification unit 4 (steps S101 to S106 in FIG. 6) are as described in the first embodiment.

In a case where the neural network is divided into a plurality of processing devices and the communication bandwidth of the communication networks between the processing devices has a large capacity, processing performance of the neural network such as a processing time and latency is less affected even when an amount of data to be exchanged increases.

Meanwhile, in a case where the communication bandwidth of the communication networks between the processing devices has a small capacity and the amount of data to be exchanged is large, a communication time caused by the exchange of data non-negligibly increases. Thus, the processing performance such as a processing time and latency is affected.

In a case where the communication bandwidth of the communication networks between the processing devices has a large capacity, the amount of data to be exchanged between the processing devices may not be constrained, or the constraint may be eased. In a case where the communication bandwidth of the communication networks between the processing devices has a small capacity, it is necessary to search for the architecture of the neural network by imposing a constraint such as reducing the number of parameters of the neural network corresponding to a portion between the processing devices, reducing the number of neurons, or applying a generally known method of reducing the number of parameters of the neural network.

In a case where the neural network is divided into a plurality of processing devices and, for example, computing performance of a second processing device is higher than computing performance of a first processing device, a processing time and latency can be reduced more by performing a large amount of computation in the second processing device than by performing a large amount of computation in the first processing device. In view of this, the architecture of the neural network is searched for such that the first processing device performs a smaller amount of computation.

In a case where the neural network is divided into a plurality of processing devices and, for example, a battery capacity of the first processing device is smaller than a battery capacity of the second processing device, inference processing can be performed for a longer time by performing a large amount of computation in the second processing device than by performing a large amount of computation in the first processing device. In view of this, the architecture of the neural network is searched for such that the first processing device performs a smaller amount of computation.

In a case where the neural network is divided into a plurality of processing devices and, for example, a memory capacity of the first processing device is smaller than a memory capacity of the second processing device, the first processing device cannot hold a large amount of data. In view of this, the architecture of the neural network is searched for such that the amount of computation and the number of parameters are reduced.

Searching for the architecture according to the constraints such as the communication bandwidth, the computing performance, the battery capacity, and the memory capacity as described above can be implemented by a setting of the table of the deployment constraint setting unit 21c.

### Effects of the Fourth Embodiment

As described above, in this embodiment, in a case where not only a conventional search condition but also a deployment constraint condition is given to the neural architecture search system, the external setting parameter, the communication network information, and the device information are collected, and constraint conditions are set. Therefore, it is possible to obtain an architecture of a neural network that can satisfy constraints of the processing devices and the communication networks and has a scale executable in the system of FIG. 2.

In this embodiment, the constraint condition is added when the architecture of the neural network is searched for, and thus it is possible to limit a search range and thus obtain, in a shorter time, the architecture of the neural network that can achieve desired inference accuracy.

In this embodiment, when the architecture of the neural network is searched for, an optimal architecture of the neural network can be obtained according to the operational precision of the processing devices. This makes it possible to restrain a decrease in the inference accuracy caused by adaptation to the operational precision of the processing devices. This embodiment eliminates the need for processing of adapting the searched-for architecture to the operational precision of the processing devices after the architecture of the neural network is searched for.

In this embodiment, in a case where the collected information includes information regarding the computing performance of the processing devices, it is possible to search for the architecture of the neural network so as to complete the inference processing in a short time. This makes it possible to reduce a processing time of inference using the neural network.

In this embodiment, in a case where the collected information includes information regarding a constraint on power consumption of the processing devices, it is possible to search for the architecture of the neural network so as to reduce an amount of computation of a processing device having a limited battery capacity or power supply. This makes it possible to operate the processing device having the limited battery capacity or power supply for a longer time.

In this embodiment, in a case where the collected information includes information regarding the memory capacities of the processing devices, it is possible to search for the architecture of the neural network so as to reduce the number of parameters for a processing device having a small memory capacity. It is also possible to search for the architecture so as to reduce memory usage caused by holding of intermediate data and also reduce the amount of computation. Further, it is also possible to search for the architecture so as to reduce the operational precision by a quantization method and also reduce an amount of intermediate data and an amount of parameter data to be held. As a result, it is possible to implement the inference processing with a smaller memory capacity and efficiently use the memories in the entire neural network system.

In this embodiment, in a case where the collected information includes information regarding power consumption caused by the processing of the communication networks, it is possible to search for the architecture of the neural network so as to reduce total power consumption of all the communication networks. This makes it possible to reduce power consumption of the neural network system.

In this embodiment, in a case where the collected information includes information regarding a processing time of the communication networks, it is possible to search for the architecture of the neural network so as to reduce an end-to-end processing time. This makes it possible to reduce the end-to-end processing time.

In this embodiment, in a case where the collected information includes information regarding an amount of communication load, it is possible to search for the architecture of the neural network so as to reduce the amount of communication load. Specifically, it is possible to search for the architecture of the neural network so as to avoid a congested path having a high communication load, such as a path having a large number of connected processing devices or a path used for a service in which large capacity data is exchanged. Therefore, it is possible not only to reduce the processing time of each communication network and reduce the end-to-end processing time, but also to reduce the communication load of the entire system or distribute the communication load.

In this embodiment, in a case where the collected information includes information regarding a communication bandwidth and the communication bandwidth has a small capacity, it is possible to search for the architecture of the neural network so as to avoid a communication network having a small capacity. Meanwhile, in a case where the communication bandwidth has a large capacity, it is possible to search for the architecture of the neural network so as to improve the inference accuracy by using a large-capacity communication network. Therefore, it is possible to search for the architecture of the neural network not only to reduce the processing time of each communication network and reduce the end-to-end processing time, but also to improve the inference accuracy.

### Extension of Embodiments

Although embodiments of the present invention have been described with reference to exemplary embodiments, the present invention is not limited to the above embodiments. Various changes that can be understood by those skilled in the art can be made in the configuration and details of the present invention within the scope of the present invention. Further, each embodiment can be implemented in any combination within a consistent range.

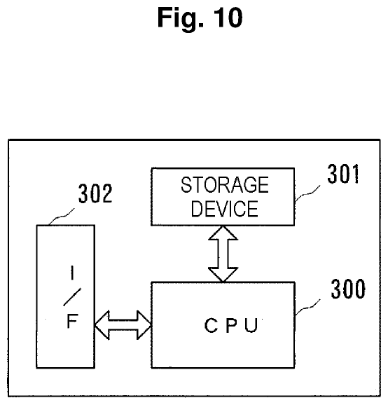

The neural architecture search systems described in the first to fourth embodiments can be implemented by a computer including a central processing unit (CPU), a storage device, and an interface and a program for controlling those hardware resources. A configuration example of the computer is illustrated in FIG. 10.

The computer includes a CPU 300, a storage device 301, and an interface device (I/F) 302. The I/F 302 is connected to, for example, an external device from which information is collected. A program for implementing the neural architecture search method of embodiments of the present invention is stored in the storage device 301. The CPU 300 executes processing described in the first to fourth embodiments according to the neural architecture search program stored in the storage device 301. The program may also be provided via a network.

### INDUSTRIAL APPLICABILITY

The embodiments can be applied to a technology of searching for an architecture of a neural network.

### REFERENCE SIGNS LIST

1 Search parameter setting unit
2 Deployment constraint management unit
3 Learning engine unit
4 Model modification unit
External setting parameter acquisition unit
21, 21a, 21b, 21c Deployment constraint setting unit
22 Communication network constraint acquisition unit
23 Device constraint acquisition unit

1.-8. (canceled)

9. A neural architecture search system comprising:
a search parameter setter configured to set a search condition of an architecture of a neural network;
a deployment constraint manager configured to convert a first constraint condition into a second constraint condition, wherein the first constraint condition defines a constraint of a system that implements the neural network and the second constraint condition defines a constraint of a parameter that prescribes the architecture of the neural network;
a learning engine configured to input training data to the neural network, perform learning of the neural network under the search condition, and calculate inference accuracy in a case where inference is performed by using the learned neural network; and
a model modifier configured to cause the learning engine to repeatedly perform the learning and the calculating of the inference accuracy while changing the architecture of the neural network based on the inference accuracy and the second constraint condition so as to obtain an architecture having a best inference accuracy.

10. The neural architecture search system according to claim 9, wherein the model modifier is configured to cause the learning engine to perform the learning and the calculating of the inference accuracy while changing the architecture of the neural network a plurality of times so as to satisfy the second constraint condition and to obtain, as a final search result, the architecture having the best inference accuracy among a plurality of architectures of the neural network obtained by the plurality of times of learning.

11. The neural architecture search system according to claim 9, wherein the learning engine is configured to repeatedly change the architecture of the neural network and perform the learning under the search condition and to obtain the architecture having the best inference accuracy as a learning result.

12. The neural architecture search system according to claim 9, wherein the first constraint condition is an external setting parameter from a user.

13. The neural architecture search system according to claim 9, wherein the first constraint condition is communication network information that defines a constraint of a communication network that connects processing devices of the system that implements the neural network.

14. The neural architecture search system according to claim 9, wherein the first constraint condition is device information that defines a constraint of processing devices of the system that implements the neural network.

15. The neural architecture search system according to claim 9, wherein the first constraint condition is an external setting parameter input by a user, communication network information that defines a constraint of a communication network that connects processing devices of the system that implements the neural network, and device information that defines a constraint of the processing devices of the system that implements the neural network.

16. A neural architecture search method comprising:
setting a search condition of an architecture of a neural network;
converting a first constraint condition into a second constraint condition, wherein the first constraint condition defines a constraint of a system that implements the neural network and the second constraint condition defines a constraint of a parameter that prescribes the architecture of the neural network;
inputting training data to the neural network, performing learning of the neural network under the search condition, and calculating inference accuracy in a case where inference is performed by using the learned neural network; and
repeatedly executing inputting the training data to the neural network, performing learning of the neural network under the search condition, and calculating the inference accuracy while changing the architecture of the neural network based on the inference accuracy and the second constraint condition so as to obtain an architecture having a best inference accuracy.

17. The neural architecture search method according to claim 16, wherein performing learning of the neural network under the search condition and calculating the inference accuracy while changing the architecture of the neural network comprises:
performing learning of the neural network under the search condition and calculating the inference accuracy while changing the architecture of the neural network a plurality of times so as to satisfy the second constraint condition; and
obtaining, as a final search result, the architecture having the best inference accuracy among a plurality of architectures of the neural network obtained by the plurality of times of learning.

18. The neural architecture search method according to claim 16, wherein performing learning of the neural network under the search condition and calculating the inference accuracy while changing the architecture of the neural network comprises:
repeatedly changing the architecture of the neural network and performing the learning under the search condition; and
obtaining the architecture having the best inference accuracy as a learning result.

19. The neural architecture search method according to claim 16, wherein the first constraint condition is an external setting parameter from a user.

20. The neural architecture search method according to claim 16, wherein the first constraint condition is communication network information that defines a constraint of a communication network that connects processing devices of the system that implements the neural network.

21. The neural architecture search method according to claim 16, wherein the first constraint condition is device information that defines a constraint of processing devices of the system that implements the neural network.

22. The neural architecture search method according to claim 16, wherein the first constraint condition is an external setting parameter input by a user, communication network information that defines a constraint of a communication network that connects processing devices of the system that implements the neural network, and device information that defines a constraint of the processing devices of the system that implements the neural network.
